(19) United States
(12) Patent Application Publication
(10) Pub. No.: US 2008/0196554 A1
(43) Pub. Date: Aug. 21, 2008

(54) Rocket socket

(76) Inventor: John Christopher Tutino, Bensalem, PA (US)

Correspondence Address: JOHN TUTINO, 3320 Johns ct., BENSALEM, PA, 19020, US

(21) Appl. No.: 12/003,496

(22) Filed: Dec. 26, 2007

Related U.S. Application Data
(60) Provisional application No. 60/880,769, filed on Jan. 17, 2007.

(51) Int. Cl. B25B 21/00

(52) U.S. Cl. 81/57.3; 81/124.3

(57) ABSTRACT

This invention compliments an improved way to use threaded rod in the construction industry. It is a unit that is drill driven and it is designed to be compatible with go-through socket inserts of various sizes and die-threading inserts of various sizes. The unit comprises a focal point for go-through socket insertion that is offset away from its drive source, which allows where said length of all-thread to bypass the base of the go-through socket and the drill.

I claim the benefits of provisional application #60/880,769 filed on Jan. 17, 2007.

This invention is a component and adapter-kit to facilitate drill compatibility with: go-through sockets and threading attachments. The component is designed to compliment the efficiency of go-through socket and hex-threading applications. It will come with a kit comprising of a set of adapters to accommodate impact gun and hex-threading insert compatibility. The drill driven component allows long bolts or threaded rod to travel through and beyond the base of a geared wrench helm that is mounted next to another geared helm with a drive shaft. The wrench helm is offset beside its geared drive source so long bolts or threaded rod will also have room to bypass over top of the drill.

### BACKGROUND OF THE INVENTION

1. FIELD OF THE INVENTION

The present invention relates to a go-through tool kit. In particular, the present invention relates to the use of a drill with a set of go-through type sockets and die threading attachments.

2. DESCRIPTION OF THE RELATED ART

A typical go-through wrench kit comprises a go-through socket wrench and multiple go-through sockets of various sizes. Each socket has a benchmark sized engaging portion in an end thereof for engaging with the inner focal point of the socket wrench. A single go-through socket wrench can be used to drive multiple go-through sockets. Further, the drive column depth of the socket wrench is no longer an issue to operation in relation to the length of the threaded bolt to which a nut is being driven because a go-through socket wrench allows any length of all-thread or bolt to bypass the base of the socket and wrench as a nut is being driven. However, the speed in which a nut is fastened by a hand operated go-through wrench is more time consuming in relation to a go-through socket that is fastened by a drill driven component.

### PRIOR ART

Summary: This tool is compatible with the typical cordless (or corded) drills and impact guns that are used by the common tradesman. Most cordless drills have keyless chucks that can adapt to various sized shafts for drill driven rotation, while few drills have hex shaped quick-change drives. Cordless impact guns have hex shaped quick-change drives ( 7/16″ or ¼″ in diameter) or a square drive (½″, ¾″, or ⅜″ in diameter). All-thread rod is widely utilized in the building trades industry. This tool can also be used to thread rod, which is valuable in situations where work is done in super sensitive laboratories or food plants (where bare rod threads can't be left out to collect dust). This go-through component and adapter set could be an efficient kit to have around.

### BRIEF DESCRIPTION OF THE DRAWINGS

FIG. 1 illustrates a view of the geared wrench helm.

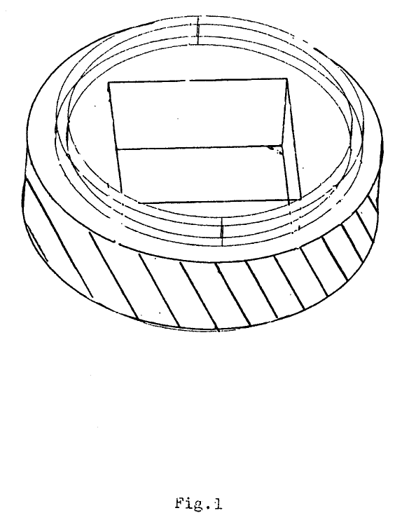

FIG. 2 illustrates a view of the geared helm that is directly driven by a ¼″ hex shaped drive shaft.

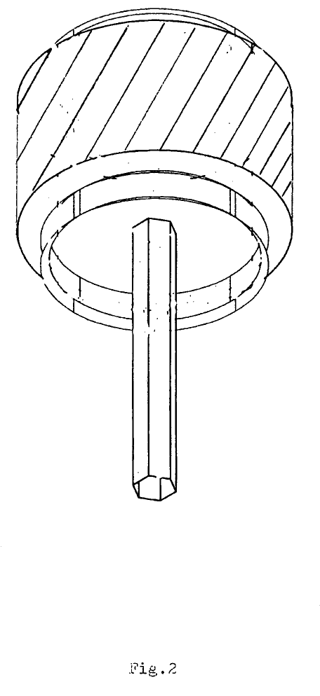

FIG. 3 illustrates a half plate of the gear housing.

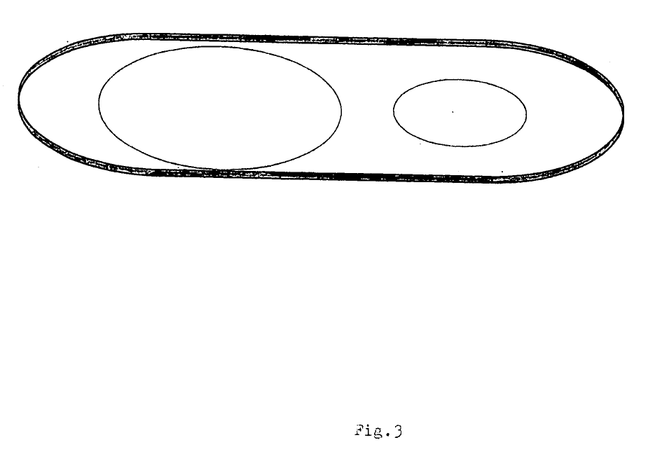

FIG. 4 illustrates a view of the component with a go-through socket.

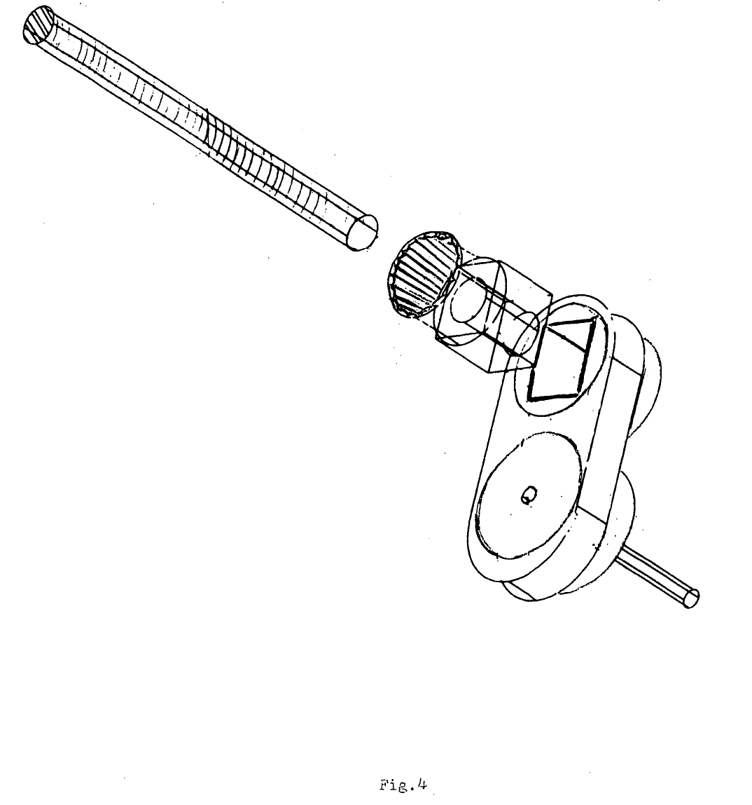

FIG. 5 illustrates a view of a wrench helm adapter for compatibility with hex shaped die threading inserts.

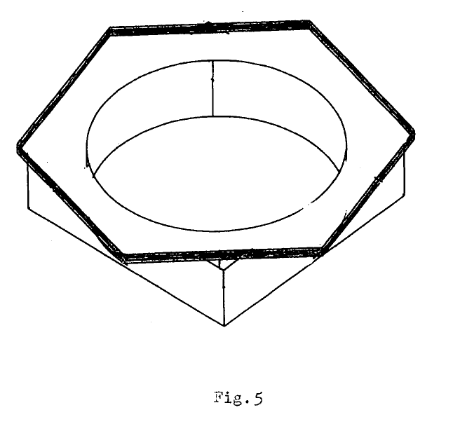

FIG. 6 illustrates one of three drive shaft adapters (½″, ¾″, and ⅜″) for an impact gun with a square drive.

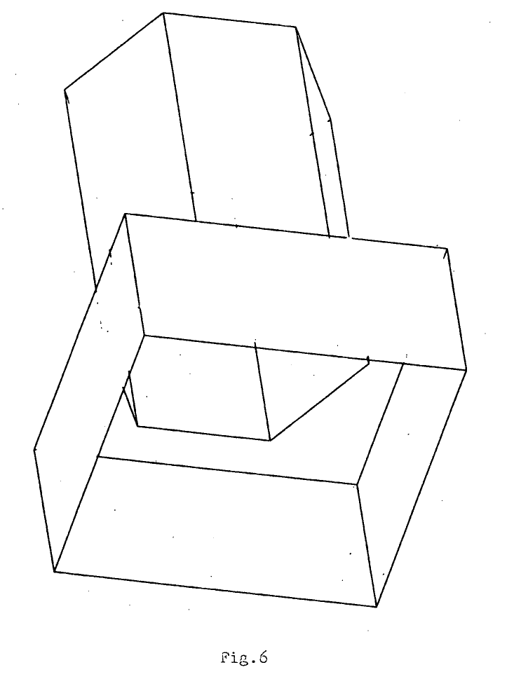

FIG. 7 illustrates a drive shaft adapter for an impact gun with a 7/16″ hex quick-change drive. Portion #1 inserts into a 7/16″ hex quick-change drive and the components' ¼″ diameter drive shaft will insert into portion #2.

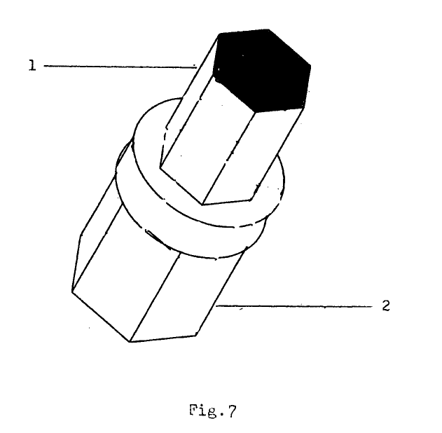

### DETAILED DESCRIPTION OF IDEAL PERSONIFICATION

A drill driven go-through kit component comprises a gear ratio that is in conformity with the torque needed to thread 1″ diameter rod with a 28-volt cordless drill. A set of adapters will come with the component so that go-through sockets and threading inserts with various sized engaging portions may unite with the inner focal point of the geared wrench helm. Both helms will have a bearing on top and bottom, which will fit inside of rings cut into the housing plates. The component will also come with a set of adapters that will enable its drive shaft to engage with various sized quick change hex drives and various sized square drives. While a detailed personification has been demonstrated and explained, various amendments and discrepancies are still achievable without parting from the groundwork of the invention. The capacity of the invention is restricted by the associated claims.

What is claimed is:

1. A drill compatible unit comprising of a focal point for go-through socket insertion that is offset away from its drive source, which allows where said length of all-thread to bypass the base of the go-through socket or die-threading insert while being drill driven. The unit includes a set of two geared helms that is Housed and interlocked to rotate when the drive shaft is spun by the drill. One helm has a hex shaped drive shaft that is ¼″ in diameter; the other helm is the geared engagement wheel that has an inner focal point with a nominal size for go-through socket and threading insert adapter compatibility.

2. The component as claimed in claim 1, with a hex shaped drive shaft sized ¼″ in diameter and will be directly compatible with a ¼″ hex quick-change drive.

3. The component as claimed in claim 1, with a set of drive shaft adapters for whichever type of drive that the drill or impact gun comprises.

4. The drive shaft adapter set as claimed in claim 3, will be sized to adapt to: 7/16″ hex quick-change drive, ¾″ square drive, ½″ square drive, and a ⅜″ square drive.

5. The component as claimed in claim 1, with an adapter set for various sized hex shaped threading inserts.

6. The adapter set as claimed in claim 5, with a focal point for hex-threading inserts that has a wall depth of 1/16″ minimum and a wrench helm engagement portion sized to be compatible with the inner focal point of the geared wrench helm.

7. The adapter sets as claimed in claims 3 & 5, will be magnetic.
